(19) United States
(12) Patent Application Publication
(10) Pub. No.: US 2023/0203625 A1
(43) Pub. Date: Jun. 29, 2023

(54) Metal material composition for additively manufactured parts

(71) Applicant: Kolibri Metals GmbH, Aamtzell (DE)

(72) Inventors: Martin HUEBNER, Ravensburg (DE); Maximilian BRONNER, Berg-Ettishofen (DE); Axel WITTIG, Wangen (DE)

(21) Appl. No.: 17/435,591

(22) PCT Filed: Feb. 7, 2020
(86) PCT No.: PCT/EP2020/053097

§ 371 Date: Mar. 16, 2022

(30) Foreign Application Priority Data
Mar. 1, 2019 (DE) 10 2019 105 223.8

(51) Int. Cl. C22C 38/28; B33Y 70/00; C22C 38/24; C22C 38/22; C22C 38/04; C22C 38/02; C22C 38/00; C22C 38/06

(52) U.S. Cl. CPC C22C 38/28; B33Y 70/00; C22C 38/001; C22C 38/02; C22C 38/002; C22C 38/04; C22C 38/06; C22C 38/22; C22C 38/24; B22F 10/28

(57) ABSTRACT

The invention relates to a method for producing precise components, preferably machining tools or cold forming tools, cold extrusion punches and dies, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.33XX or DIN EN 10027-2 no. 1.27XX, in particular according to the standard DIN EN 10027-2 no. 1.3343 with the short name HS6-5-2C or DIN EN 10027-2 no. 1.2709, a powder alloy being created from said powder elements over the course of the laser sintering process, wherein the following powder elements, present in elemental, alloyed or pre-alloyed form, are each additionally added to the alloy separately or in arbitrary combination: tungsten in the range of between 35, 10 and 0.7 mass%, preferably 10 mass%, titanium in the range of between 0.2, 3.2 to 10.7 mass%, preferably 3.2 mass%, carbon in the range of between 0.08, 1.23 up to 4.1 mass%, preferably 1.23 mass%, O in the range of between 0.00 up to 0.02 mass%, N in the range of between 0.00 up to 0.02 mass%, undefined residual substances at less than 0.1 mass%.

A metal material composition according to the preamble of claim 1 has become known, for example, in the subject matter of DE 100 39 144 C1 or WO2002/11928 A1. There, a method for producing precise components by laser melting or laser sintering of a powder material is described. It is proposed there that metal powder mixtures are produced using 3 components. The aim is to increase the melting temperature of the final component.

When this goal is achieved, the cited publication provides that iron and other powder constituents are used as the main constituent of the metal powder composition and are present in elemental, pre-alloyed or partially pre-alloyed form. The main constituent, iron, in the powder mixture is supplemented by further powder elements, which are added separately or in arbitrary combination, for example the invention relates to a method for producing precise components according to the preamble of the main claim.

It is recognized that admixing these materials in the indicated admixture ranges certainly leads to an increase in the melting temperature of the final component. However, adding the above-mentioned components does not necessarily and inevitably improve the hardness of the workpiece produced therewith.

The object of the invention is therefore to improve a metal material composition for additive 3D laser melting (SLM) or laser sintering (SLS) or deposit welding or binder jetting or fused deposition modeling (FDM) of the type mentioned above such that an improved hardness and an improved abrasiveness of the workpiece produced therewith is achieved.

To achieve this object, the invention is characterized by the technical teaching of the independent claims.

When application examples that relate to laser melting (SLM) are described in the following description, this is not to be understood as restrictive. This is merely done for the sake of simplicity of description. All embodiments in which the use of the SLM method is described also apply analogously to laser sintering (SLS) or laser deposit welding or binder jetting or fused deposition modeling (FDM) without this being explicitly mentioned.

Binder jetting (also known as 3D printing) is an additive manufacturing process in which powdered starting material is bonded using a binder at selected points in order to create workpieces.

Fused deposition modeling (FDM) or fused filament fabrication (FFF) refers to a manufacturing process from the field of 3D printing by means of which a workpiece is built up in layers from a meltable plastics material or — in newer technologies — from molten metal.

The five methods mentioned above can be used individually or in any combination with one another to produce a metal workpiece.

The composition according to DIN standard 1.3343 is mentioned as an example of a known metal material composition for additively manufacturing steel, a powdered base material being used in a preferred embodiment according to the invention. So far, however, it was only known in SLM technology to turn all the metal materials defined in DIN standards into powder and to process them in a 3D printer, which, however, led to inadequate workpiece qualities.

The invention therefore takes advantage of the SLM method or laser sintering (SLS) or deposit welding or binder jetting or fused deposition modeling (FDM) to improve the conventional powder preparation by adding special powder preparations, in that specific particles that cannot be added conventionally, for example in the extrusion plant, are added. In a preferred embodiment, this is a ceramic powder composition that is sold under the name XW0625.

If steel and ceramic material were poured into a conventional crucible and the mixture were heated to the melting temperature, the ceramic material would float at the top with the steel below and it would not be possible to achieve a uniform microstructure in the workpiece cast therefrom.

The invention therefore relates to all of the following fields of application, namely SLM (laser melting) and/or SLS (laser sintering) and/or laser deposit welding and/or FDM and/or binder jetting methods.

In a preferred embodiment, ceramic powder is mixed at a mass% of up to 15% with the steel powder and then processed in the SLM or SLS and/or laser deposit welding and/or FDM and/or binder jetting method.

This results in a uniformly distributed microstructure of ceramic particles in the steel. The ceramic particles are not melted by the laser, only the metal particles are melted, and therefore the unmelted ceramic particles are evenly embedded in the molten metal microstructure. This results in a new type of metal-ceramic matrix for the workpiece produced in this way.

However, the addition of 15 mass% in the matrix material is only a preferred variant. A proportion of 30% or 32 mass% of the ceramic material may also be embedded in the metal matrix.

The term “ceramic material” used here is synonymous with the term “carbides.” In particular, the powder composition XW0625 may be referred to as both a ceramic and a carbide powder composition.

This results in the technical teaching of the invention of mixing a steel powder according to various DIN standards, which will be specified later, with a ceramic powder of various compositions in order to achieve superior material properties compared to the starting materials.

It is preferred if the ceramic material is not melted in the SLM method but rather only the steel, and the ceramic materials are then embedded in the steel matrix.

The advantage of the invention is that, due to the material composition in the molten workpiece, there is now a matrix of molten steel in which unmelted ceramic particles are embedded.

Preferably ⅙ of the spatial volume of the molten steel is evenly interspersed with ceramic particles.

There are other advantages of using the method according to the invention:

Ceramic material has a very high hardness, but low toughness. In terms of its properties, it corresponds to a pane of glass that is fragile.

In contrast, steel is the opposite, because steel has a low hardness but very high toughness. In the case of hard metal, the high hardness comes from embedded ceramic particles. In the case of steel, the high toughness comes from the metal and the invention exploits the advantages of hard metal in the mixture, namely the hardness of ceramic material and the toughness of steel, and therefore both properties are combined in one material.

Hard metal is a metal matrix composite material consisting of cobalt and carbides, and carbides are to be regarded as ceramic materials at the same time. The cobalt is present in the hard metal at a proportion of approximately 15% and the ceramic material or carbides make up 85% of the mass.

The comparison with hard metal is merely an analogy, which means that, in the present invention, no hard metal or hard metal particles are added, but only a comparison is made that a steel refined with hard metal also has the required positive properties, just as in the present invention the steel powder also has the superior properties when mixed with ceramic powder.

In a preferred embodiment, the invention claims, among other things, protection of the following items alone or in any combination with one another:

The invention claims various classes of material which, with the generalization XX, correspond to the following DIN standard classes. The sequence of letters XX substitutes a two-digit combination on the end of the relevant DIN standard:
DIN 1.33XX, preferably, but not limited to DIN 1.3343
DIN 3.71XX, preferably, but not limited to DIN 3.7165
DIN 1.23XX, preferably, but not limited to DIN 1.2379
DIN 1.44XX, preferably, but not limited to DIN 1.4404
DIN 1.45XX, preferably, but not limited to DIN 1.4562
DIN 1.27XX, preferably, but not limited to DIN 1.2709
DIN 3.23XX, preferably, but not limited to DIN 1.2383
DIN 2.08XX, preferably, but not limited to DIN 2.0855
INCONEL XXX, preferably, but not limited to INCONEL 718.

Above, a preferred material from the relevant class is derived from the relevant class specification, although the invention is not limited to this specific material.

In a generalized embodiment, the preferred processing of the materials of the hard metal classes is set out, with the letter combination being the placeholder for a two-digit natural number, to which the invention is not limited:
1. Processing the material 1.33XX or 3.71XX or 1.23XX or 1.44XX or 1.45XX or 1.27XX in the SLM method and/or SLS and/or laser deposit welding and/or FDM and/or binder jetting method
2. Mixing the 1.33XX or 3.71XX or 1.23XX or 1.44XX or 1.45XX or 1.27XX material with carbides
3. In particular, mixing the 1.33XX or 3.71XX or 1.23XX or 1.44XX or 1.45XX or 1.27XX material with 1% to 50% carbides
4. Mixing the base material with carbides according to number 3 in the SLM method
5. Mixing the selected materials mentioned here with carbides
6. Mixing powder components according to numbers 2 to 5 with boron nitrides
7. General mixing of base material with carbides for additive manufacturing (FDM, LAS...)
8. Adding diamond powder to all powder preparations according to numbers 1 to 7.

In a preferred, specific embodiment, the processing of the specific preferred materials of the hard metal classes is set out, to which, however, the invention is not limited:
1. Processing the material 1.3343 or 3.7165 or 1.2379 or 1.4404 or 1.4562 or 1.2709 in the SLM method and/or SLS and/or laser deposit welding and/or FDM and/or binder jetting method
2. Mixing the 1.3343 or 3.7165 or 1.2379 or 1.4404 or 1.4562 or 1.2709 material with carbides
3. In particular, mixing the 1.3343 or 3.7165 or 1.2379 or 1.4404 or 1.4562 or 1.2709 material with 1% to 50% carbides
4. Mixing the base material with carbides according to number 3 in the SLM method
5. Mixing the selected materials mentioned here with carbides
6. Mixing powder components according to numbers 2 to 5 with boron nitrides
7. General mixing of base material with carbides for additive manufacturing (FDM, LAS...)
8. Adding diamond powder to all powder preparations according to numbers 1 to 7.

### 1st Example

A first preferred embodiment relates to a
method for producing precise components, preferably
machining tools or cold forming tools, cold extrusion punches and dies, by laser melting or
laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.3343 with the short name HS6-5-2C or DIN EN 10027-2 no. 1.2709:

TABLE 3

| | |
|---|---|
| 1.1 | Iron: up to 79.50 mass%, |
| 1.2 | Carbon: from 0.86 to 0.94 mass%, |
| 1.3 | Chromium: from 3.80 to 4.50 mass%, |
| 1.4 | Manganese: less than 0.40 mass%, |
| 1.5 | Phosphorus: up to 0.03 mass%, |
| 1.6 | Sulfur: up to 0.03 mass%, |
| 1.7 | Silicon: less than 0.45 mass%, |
| 1.8 | Vanadium: from 1.70 up to 2.00 mass%, |
| 1.9 | Tungsten: from 5.9 up to 6.7 mass%, |
| 1.10 | Molybdenum: from 4.7 to 5.2 mass%, |

a powder alloy being created from said powder elements over the course of the laser melting process, the following powder elements, present in elemental, alloyed or pre-alloyed form, each being additionally added to the alloy separately or in arbitrary combination:

TABLE 3A

| | |
|---|---|
| 1.11 | Tungsten: in the range of between 0.7, 10 and 35 mass%, preferably 10 mass%, |
| 1.12 | Titanium: in the range of between 0.2, 3.2 to 10.7 mass%, preferably 3.2 mass%, |
| 1.13 | Carbon: in the range of between 0.08, 1.23 up to 4.1 mass%, preferably 1.23 mass%, |
| 1.14 | O: in the range of between 0.00 up to 0.02 mass%, |
| 1.15 | N: in the range of between 0.00 up to 0.02 mass%, |
| 1.16 | Undefined residual substances at less than 0.05 mass%. |

### 2nd Example

A second preferred embodiment relates to a

method for producing precise components, preferably high-strength components for the aerospace industry in order to achieve high strength with good toughness at a low density, good hot formability and weldability, by laser sintering or laser melting or laser deposit welding or FDM or binder jetting of a powder material, which consists of a mixture of at least two powder elements, the powder mixture being formed by the primary component titanium powder and additional powder alloying elements, which are present in elemental, pre-alloyed or partially pre-alloyed form, the powder elements each being added separately or in arbitrary combination in the following quantities according to the standard DIN EN 10027-2 no. 3.7165 with the short name Titan Grade 5:

TABLE 4

| | |
|---|---|
| 2.1 | Titanium: in the range of between 88.74 and 91 mass%, |
| 2.2 | Aluminum: in the range of between 5.50 and 6.75 mass%, |
| 2.3 | Vanadium: in the range of between 3.50 and 4.50 mass%, |
| 2.4 | Hydrogen (H): less than 0.02 mass%, |

a powder alloy being created from said powder elements over the course of the laser melting process, the following powder elements, present in elemental, alloyed or pre-alloyed form, each being additionally added to the alloy separately or in arbitrary combination:

TABLE 4A

| | |
|---|---|
| 2.5 | Tungsten: in the range of between 0.7, 10 and 35 mass%, preferably 10 mass%, |
| 2.6 | Titanium: in the range of between 0.2, 3.2 to 10.7 mass%, preferably 3.2 mass%, |
| 2.7 | Carbon: in the range of between 0.08, 1.23 up to 4.1 mass%, preferably 1.23 mass%, |
| 2.8 | O: in the range of between 0.00 up to 0.02 mass%, |
| 2.9 | N: in the range of between 0.00 up to 0.02 mass%, |
| 2.10 | Undefined residual substances at less than 0.05 mass%. |

### 3rd Example

A third embodiment relates to a
method for producing precise components, preferably
machining tools or cold forming tools, in particular high-performance cutting tools (dies and punches);
milling cutters, broaches; sectioning, punching and cutting tools; thread rolling and rolling tools;
woodworking tools; machine knives; plastics molds, measuring tools, tools for stamping technology;
drawing, deep-drawing and extrusion tools; pressing tools for the ceramic and pharmaceutical industry; cold rolls for multi-roll stands; forming and bending tools, by laser melting or laser sintering of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.2379 with the short name X155CrVMo12-1 and the chemical composition C 1.55 / Si 0.4 / Mn 0.3 / Cr 11.8 / Mo 0.75 / V 0.82 or other chromium-nickel steels being added, in particular if the chemical composition is quantified as follows:

TABLE 5

| | |
|---|---|
| 3.1 | Iron: up to 84.05 mass%, |
| 3.2 | Carbon: up to 1.55 mass%, |
| 3.3 | Chromium: up to 12.00 mass%, |
| 3.4 | Molybdenum: up to 0.80 mass%, |
| 3.5 | Vanadium: up to 0.90 mass%, |
| 3.6 | Silicon: up to 0.40 mass%, |
| 3.7 | Manganese: up to 0.30 mass%, |

the following powder elements, present in elemental, alloyed or pre-alloyed form, each being additionally added to the alloy separately or in arbitrary combination:

TABLE 5A

| | |
|---|---|
| 3.8 | Tungsten: in the range of between 0.7, 10 and 35 mass%, preferably 10 mass%, |
| 3.9 | Titanium: in the range of between 0.2, 3.2 to 10.7 mass%, preferably 3.2 mass%, |
| 3.10 | Carbon: in the range of between 0.08, 1.23 up to 4.1 mass%, preferably 1.23 mass%, |
| 3.11 | O: in the range of between 0.00 up to 0.02 mass%, |
| 3.12 | N: in the range of between 0.00 up to 0.02 mass%, |
| 3.13 | Undefined residual substances at less than 0.05 mass%. |

### 4th Example

A fourth embodiment relates to a

method for producing precise components from austenitic stainless steel 1.4404 (316 L) with good acid resistance, preferably for chemical apparatus construction, in sewage treatment plants and in the paper industry, for mechanical components with increased requirements for corrosion resistance, in particular in media containing chloride and for hydrogen, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.4404 with the EN short name X2CrNiMo17-12-2:

TABLE 6

| | |
|---|---|
| 4.1 | Iron: up to 62.80 mass%, |
| 4.2 | Carbon: up to 0.03 mass% |
| 4.3 | Silicon: up to 1.00 mass%, |
| 4.4 | Manganese: up to 2.00 mass%, |
| 4.5 | Phosphorus: up to 0.05 mass%, |
| 4.6 | Sulfur: up to 0.02 mass%, |
| 4.7 | Chromium: in the range of between 16.50 and 18.50 mass%, |
| 4.8 | Molybdenum: in the range of between 2.00 up to 2.50 mass%, |
| 4.9 | Nickel: in the range of between 10.00 up to 13.00 mass%, |
| 4.10 | Nitrogen: up to 0.11 mass%, |

the following powder elements, present in elemental, alloyed or pre-alloyed form, each being additionally added to the alloy separately or in arbitrary combination:

TABLE 6A

| | |
|---|---|
| 4.11 | Tungsten: in the range of between 0.7, 10 and 35 mass%, preferably 10 mass%, |
| 4.12 | Titanium: in the range of between 0.2, 3.2 to 10.7 mass%, preferably 3.2 mass%, |
| 4.13 | Carbon: in the range of between 0.08, 1.23 up to 4.1 mass%, preferably 1.23 mass%, |
| 4.14 | O: in the range of between 0.00 up to 0.02 mass%, |
| 4.15 | N: in the range of between 0.00 up to 0.02 mass%, |
| 4.16 | Undefined residual substances at less than 0.05 mass%. |

### 5th Example

A fifth embodiment relates to a

method for producing precise components from an iron-nickel-chromium-molybdenum alloy with the addition of nitrogen, preferably for use in chemistry and petrochemistry, in ore digestion plants, in environmental and marine technology, and in oil and gas extraction, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.4562 with the EN material short name X1NiCrMoCu32-28-7:

TABLE 7

| | |
|---|---|
| 5.1 | Iron: up to 60.92 mass%, |
| 5.2 | Carbon: up to 0.02 mass%, |
| 5.3 | Silicon: up to 0.30 mass%, |
| 5.4 | Manganese: up to 2.00 mass%, |
| 5.5 | Phosphorus: up to 0.02 mass%, |
| 5.6 | Sulfur: up to 0.10 mass%, |
| 5.7 | Chromium: in the range of between 26.00 and 28.00 mass%, |
| 5.8 | Copper: in the range of between 1.00 and 1.40 mass%, |
| 5.9 | Nickel: in the range of between 30 and 32 mass%, |
| 5.10 | Molybdenum: in the range of between 6.00 and 7.00 mass%, |
| 5.11 | Nitrogen: in the range of between 0.15 and 0.25 mass%, |

the following powder elements, present in elemental, alloyed or pre-alloyed form, each being additionally added to the alloy separately or in arbitrary combination:

TABLE 7A

| | |
|---|---|
| 5.12 | Tungsten: in the range of between 0.7, 10 and 35 mass%, preferably 10 mass%, |
| 5.13 | Titanium: in the range of between 0.2, 3.2 to 10.7 mass%, preferably 3.2 mass%, |
| 5.14 | Carbon: in the range of between 0.08, 1.23 up to 4.1 mass%, preferably 1.23 mass%, |
| 5.15 | O: in the range of between 0.00 up to 0.02 mass%, |
| 5.16 | N: in the range of between 0.00 up to 0.02 mass%, |
| 5.17 | Undefined residual substances at less than 0.05 mass%. |

### 6th Example

A sixth embodiment relates to a method for producing precise components, preferably machining tools as high-speed steel with high toughness and good cutting performance or cold forming tools, in particular high-performance cutting tools (dies and punches); milling cutters, broaches; sectioning, punching and cutting tools; thread rolling and rolling tools; woodworking tools; machine knives; plastics molds, measuring tools, tools for stamping technology; drawing, deep-drawing and extrusion tools; pressing tools for the ceramic and pharmaceutical industry; cold rolls for multi-roll stands; forming and bending tools, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.3343 with the short name HS6-5-2C or other chromium-nickel steels being added, in particular if the chemical composition is quantified as follows:

TABLE 8

| | |
|---|---|
| 6.1 | Iron: up to 79.75 mass%, |
| 6.2 | Carbon: in the range of between 0.86 and 0.94 mass%, |
| 6.3 | Chromium: in the range of between 3.80 and 4.50 mass%, |
| 6.4 | Manganese: less than 0.40 mass%, |
| 6.5 | Phosphorus: less than 0.03 mass%, |
| 6.6 | Sulfur: up to 0.03 mass%, |
| 6.7 | Silicon: less than 0.45 mass%, |
| 6.8 | Vanadium: in the range of between 1.70 up to 2.00 mass%, |
| 6.9 | Tungsten: in the range of between 5.9 up to 6.7 mass%, |
| 6.10 | Molybdenum: in the range of between 4.7 up to 5.2 mass%, |

the following powder elements, present in elemental, alloyed or pre-alloyed form, each being additionally added to the alloy separately or in arbitrary combination:

TABLE 8A

| | |
|---|---|
| 6.11 | Carbon in the form of diamond powder: in the range of between 1, 15 to 50 mass%, preferably 15 mass%. |

### 7th Example

A seventh embodiment relates to a

method for producing precise components, preferably machining tools as high-speed steel with high toughness and good cutting performance or cold forming tools, in particular high-performance cutting tools (dies and punches); milling cutters, broaches; sectioning, punching and cutting tools; thread rolling and rolling tools; woodworking tools; machine knives; plastics molds, measuring tools, tools for stamping technology; drawing, deep-drawing and extrusion tools; pressing tools for the ceramic and pharmaceutical industry; cold rolls for multi-roll stands; forming and bending tools, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.3343 with the short name HS6-5-2C or other chromium-nickel steels being added, in particular if the chemical composition is quantified as follows:

TABLE 9

| | |
|---|---|
| 7.1 | Iron: up to 79.75 mass%, |
| 7.2 | Carbon: in the range of between 0.86 and 0.94 mass%, |
| 7.3 | Chromium: in the range of between 3.80 and 4.50 mass%, |
| 7.4 | Manganese: less than 0.40 mass%, |
| 7.5 | Phosphorus: less than 0.03 mass%, |
| 7.6 | Sulfur: up to 0.03 mass%, |
| 7.7 | Silicon: less than 0.45 mass%, |
| 7.8 | Vanadium: in the range of between 1.70 up to 2.00 mass%, |
| 7.9 | Tungsten: in the range of between 5.9 up to 6.7 mass%, |
| 7.10 | Molybdenum: in the range of between 4.7 up to 5.2 mass%, |

the following powder elements, present in elemental, alloyed or pre-alloyed form, each being additionally added to the alloy separately or in arbitrary combination:

TABLE 9A

| | |
|---|---|
| 7.11 | Boron: up to 56.18 mass%, |
| 7.12 | Nitrogen: up to 43.53 mass%. |

In all of the above-mentioned cases, the addition of carbides improves the dimensional stability of the body produced in the SLM process during hardening. Another decisive advantage results from the improved abrasiveness. However, the properties of breaking strength and ductility remain unchanged compared to the untreated starting material.

According to a preferred embodiment (6th example) of the invention, a composition according to DIN 1.3343 according to the following table is used as the starting material for the metal material composition.

The following Table 1 shows the chemical composition of the metal starting material according to DIN 1.3343.

TABLE 1

| | |
|---|---|
| Properties | |
| Forging | 1100-900° C. |
| Soft annealing | 780-820° C. 2-4 hours |
| Annealed hardness | Max 300 HB |
| Stress relief annealing | |
| Preheating for hardening | Heat to 450° C., in one stage preheat to 850° C. |
| Hardening | 1190-1230° C. dry air flow or salt bath 500-550° C. (64-66 HRC = stand. working hardness) |
| Tempering | 540-560° C. at least 2×1 h or as per tempering plate |
| Elements min max | [image] |

In a preferred embodiment of the present invention, the substances specified in Table 1 are present in a powdered admixture in a proportion by weight of 85%, and a material composition substantially in the form of ceramic powder is admixed with an admixture value in the range of from approximately 10% to 50%, with 15% being preferred.

This configuration of the metal powder materials to be admixed is shown in the following Table 2:

TABLE 2

Screen analysis

| Rotap ASTM B214 | | Microtrac ASTM B822 | | Specification | | |
|---|---|---|---|---|---|---|
| µm | wt.% | µm | % pass | Measurement method | value | unit |
| +45 | 0 | | | Rotap | | wt.% |
| -45+20 | Balance | | | Rotap | | wt.% |
| -20 | 47.17 | | | Rotap | | wt.% |
| | | -20 | 28.04 | | | |
| | | -10 | 6.6 | | | |
| | | -5 | 1.71 | | | |

ASTM B212 Apparent Density: 3.80 g/cc

[image]

The preferred feature of the invention is therefore that the ceramic powder materials specified in Table 2 are admixed in the above-mentioned preferred admixture range (in percent by weight) of the metal powder mixture according to Table 1, and ultimately results in a composite powder material which thus has superior properties in the selective laser melting method (SLM) or laser deposit welding or FDM or binder jetting with regard to the material quality achieved.

It is preferred if powdered boron nitrides and/or a powdered diamond powder and/or a powdered carbide powder are added to the powder composition according to any of claims 1 to 7.

And furthermore if the boron nitride and/or carbide and/or diamond powder bodies used have a cubic shape (CBN) and/or a broken shape with a grain size in the range of between 1 to 40 micrometers.

And furthermore, the melting temperature of the ceramic and/or carbide powder composition used is far above the melting temperature of the metal powder compositions and only the metal powder compositions are melted in the SLM process or SLS or SLM process or laser deposit welding or FDM or binder jetting.

The subject matter of the present invention results not only from the subject matter of the individual claims, but also from the combination of the individual claims with one another.

All information and features disclosed in the documents, including the abstract, in particular the spatial configuration shown in the drawings, could be claimed to be essential to the invention insofar as they are novel over the prior art, individually or in combination. The use of the terms “essential” or “according to the invention” or “essential to the invention” is subjective and does not imply that the features mentioned in this regard must necessarily be part of one or more of the claims.

The powder and powder compositions used are preferably used in a grain size range of between 1 to 45 micrometers.

In the following, the invention is explained in more detail on the basis of tables that merely show several possible embodiments. Further features and advantages of the invention that are essential to the invention are clear from the drawings and the description thereof.

In the tables and drawings:

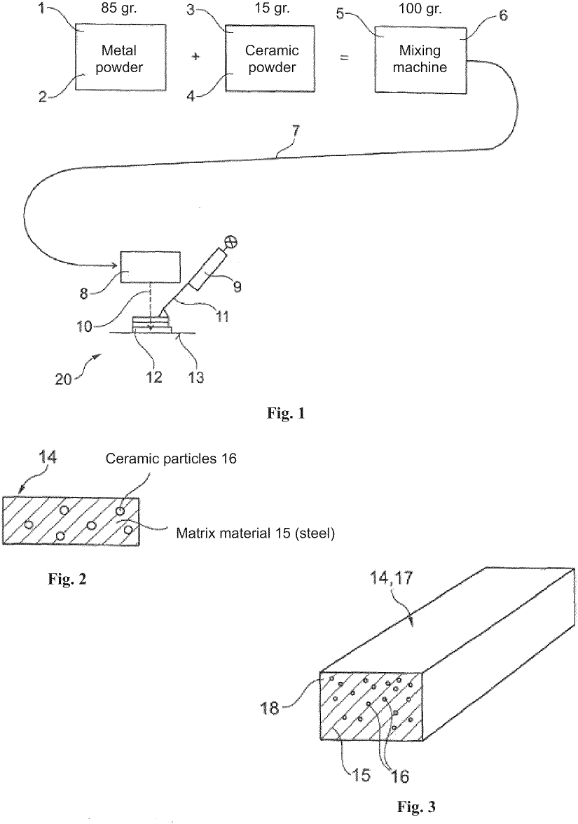

FIG. 1: schematically shows a method sequence for the laser melting method.

FIG. 2: is a schematic sectional view through a workpiece manufactured according to the SLM method.

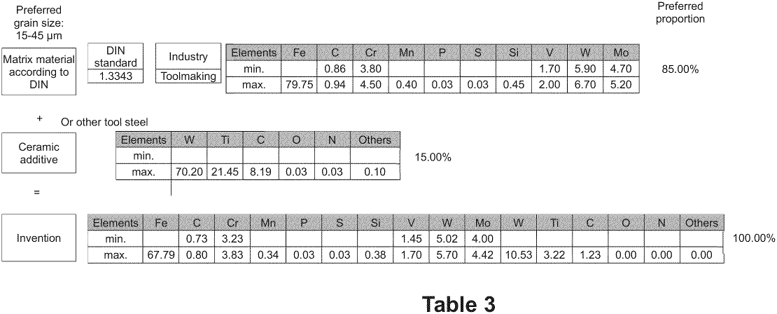

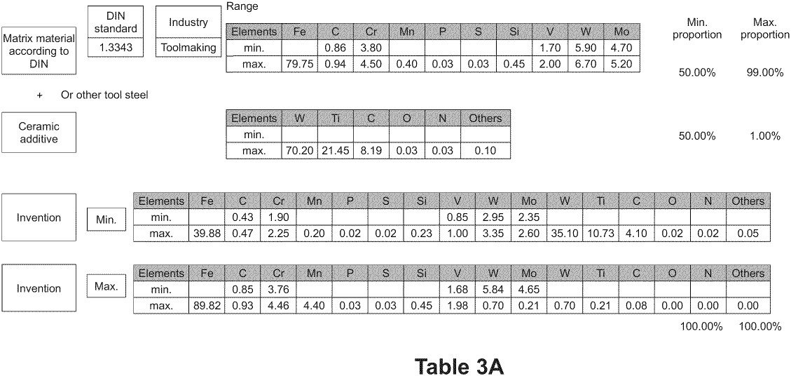

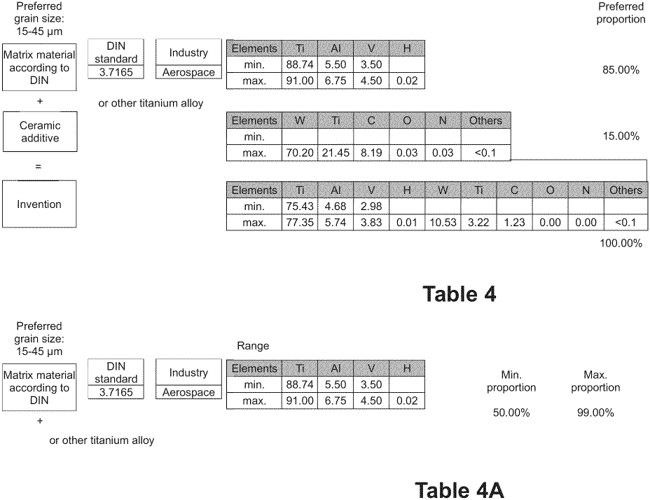

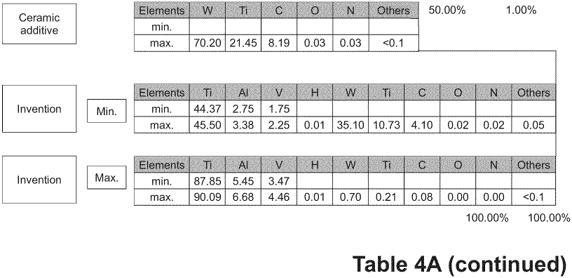

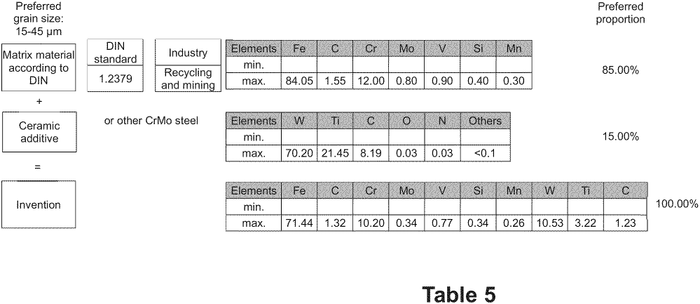

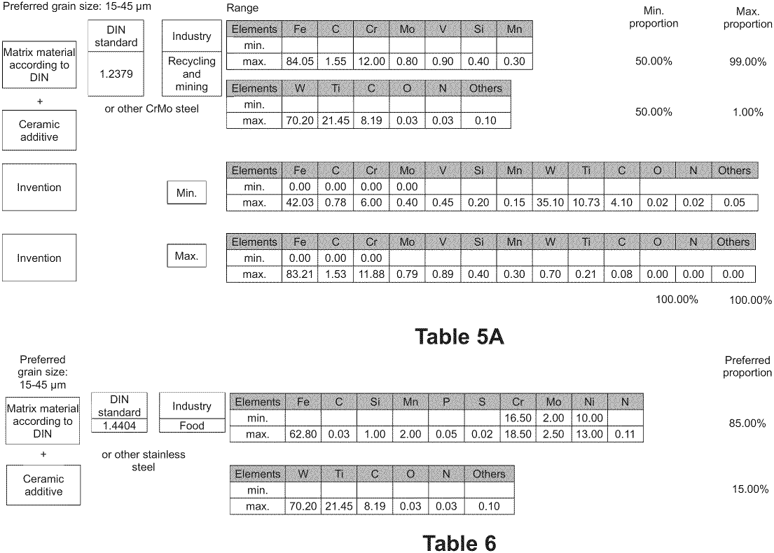

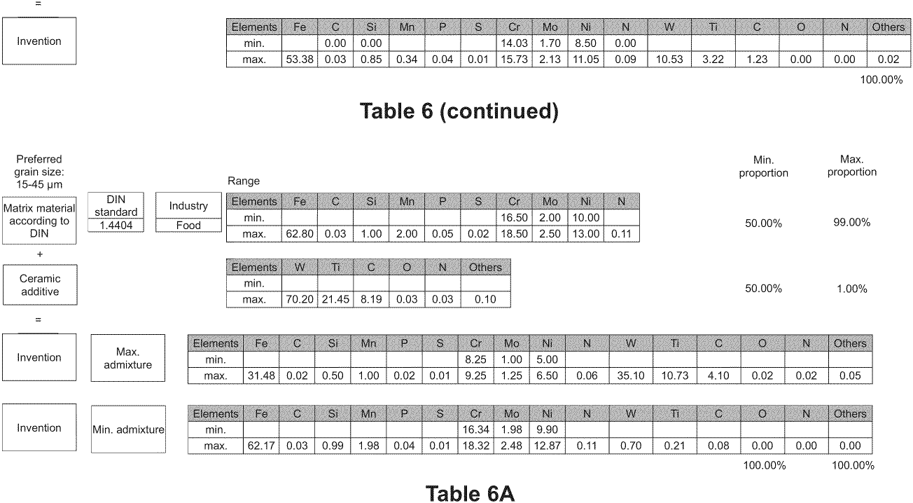

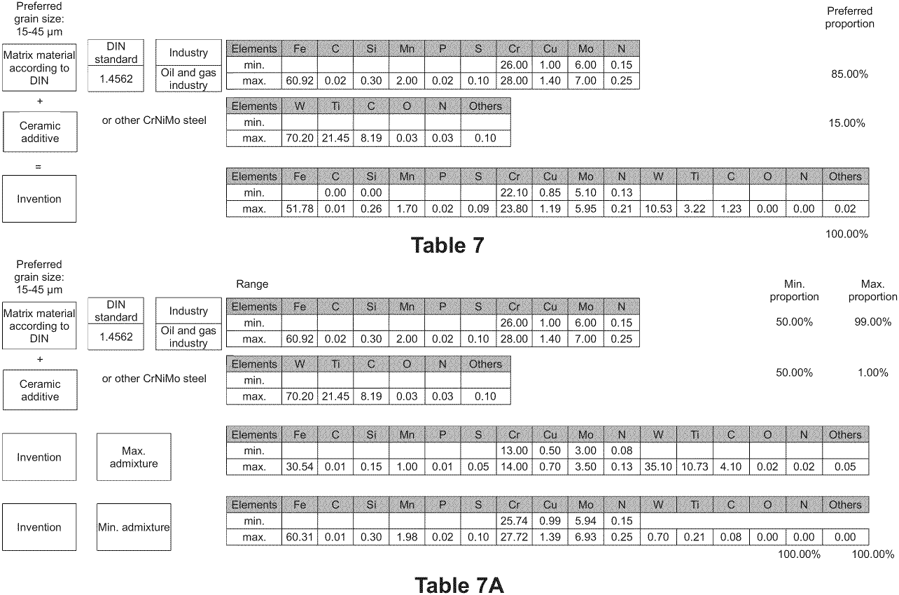

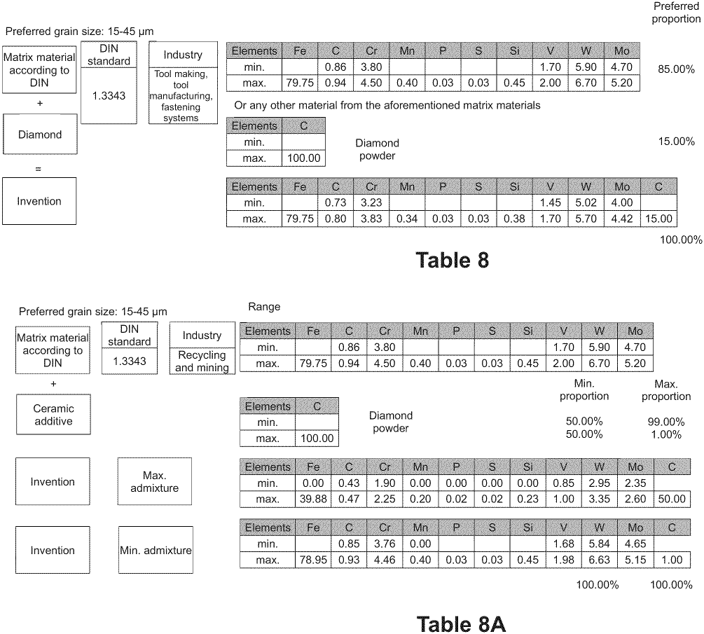

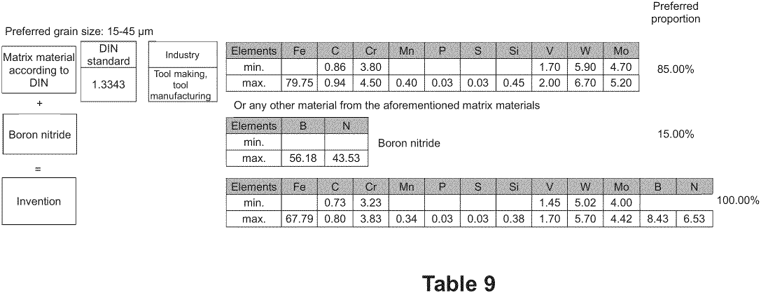

FIG. 3: is an approximately identical representation to FIG. 2.

Table 3: Presentation of the powder composition based on the material 1.3343 in combination with a ceramic powder additive mixture.

Table 3A: shows the powder composition obtained from Table 3 with details of the admixture ranges, with minimum admixture values being indicated in a sub-table and maximum admixture values indicated in another sub-table.

Tab. 4: Presentation of the powder composition based on the material 3.7165 in combination with a ceramic powder additive mixture.

Table 4A: shows the powder composition obtained from Table 4 with details of the admixture ranges, with minimum admixture values being indicated in a sub-table and maximum admixture values indicated in another sub-table.

Tab. 5: Presentation of the powder composition based on the material 1.2379 in combination with a ceramic powder additive mixture.

Table 5A: shows the powder composition obtained from Table 5 with details of the admixture ranges, with minimum admixture values being indicated in a sub-table and maximum admixture values indicated in another sub-table.

Tab. 6: Presentation of the powder composition based on the material 1.4404 in combination with a ceramic powder additive mixture.

Table 6A: shows the powder composition obtained from Table 6 with details of the admixture ranges, with minimum admixture values being indicated in a sub-table and maximum admixture values indicated in another sub-table.

Tab. 7: Presentation of the powder composition based on the material 1.4562 in combination with a ceramic powder additive mixture.

Table 7A: shows the powder composition obtained from Table 7 with details of the admixture ranges, with minimum admixture values being indicated in a sub-table and maximum admixture values indicated in another sub-table.

Tab. 8: Presentation of the powder composition based on the material 1.3343 in combination with a diamond powder additive mixture.

Table 8A: shows the powder composition obtained from Table 8 with details of the admixture ranges, with minimum admixture values being indicated in a sub-table and maximum admixture values indicated in another sub-table.

Tab. 9: Presentation of the powder composition based on the material 1.3343 in combination with a boron nitrite powder additive mixture.

FIG. 1 is a broad representation of a powder composition consisting of a metal powder composition 2 which is stored in a first container 1. A ceramic powder composition 4 according to the invention is provided for this metal powder composition in another container 3 and is mixed together and homogenized in a homogenizing machine 6 so as to form a powder mixture 5.

The final powder mixture 5 is fed by means of the belt 7 to a 3D laser melting machine 20, where it is poured into a tank 8.

To produce the new type of workpiece 14, a material jet 10 is then directed from the tank 8 in the direction of a construction plate 13 and, at the same time, this material composition is irradiated with the laser beam 11 by a laser gun 9, such that a vertically built-up layer structure 12 is produced.

By way of example, each layer may have a thickness of 40 micrometers. However, the invention is not restricted to this. Other layer thicknesses may be used, it being preferred for the individual layers to merge homogeneously with one another and form a uniform, homogeneous workpiece.

The workpiece 14 produced in the layer structure is shown schematically in FIG. 2 and, according to the invention, its primary component consists of a matrix material 15 that corresponds to the metal base material of the metal powder composition 2, the ceramic particles 16 of the ceramic powder composition 4 now evenly melted into the material composite of the matrix material.

It is therefore a combination material, the internal structure of which has been significantly improved by admixing or embedding a ceramic powder composition, the ceramic particles having a particle size of between 1 and 45 micrometers.

The density of the ceramic particles in the matrix material 15 is in the range of from 1.0 to 5.0, but preferably 3.80 g/cm³.

The particles may be embedded in a spherical shape, i.e. in a ball, cone or other ball-like shape, but they may also be provided as broken particles, which exhibit even better adhesion and bonding in the metal material.

It is obvious that the mechanical properties of the workpiece 14 later produced with said particles can also be altered depending on whether the ball shape or broken shape is used.

A workpiece 14 of this kind is shown, for example, in FIG. 3, which is designed as a material punch 17, for example.

The sectional image 18 shows the material structure in the tool punch 17 in a merely schematic manner.

Instead of a tool punch 17 of this kind, any other metal workpieces 14 having the superior properties can be produced, such as inserts for tools, inserts for drills, wearing parts in the food industry, in particular stirrers, mixers, nozzles and the like. In the oil and pipeline industry, too, nozzles are used, the parts of which that are exposed to wear are made from the superior material of the workpiece 14.

With the production of a new type of workpiece 14, the invention can accordingly be used in all areas where particularly hard and wear-resistant metal parts that can also be machined easily are to be used.

It is particularly advantageous that the method according to the invention substantially does not change the basic properties (hardness, toughness, rigidity, flexural fatigue strength) of the metal material used; this produces the advantage that only minor changes to the conditions of use have to be taken into account during processing and use. Nevertheless, a material similar to hard metal is produced, the abrasiveness of which is significantly increased.

Reference sign list

| | |
|---|---|
| 1. | Container |
| 2. | Metal powder composition |
| 3. | Container |
| 4. | Ceramic powder composition |
| 5. | Powder mixture |
| 6. | Homogenizing machine |
| 7. | Path |
| 8. | Tank |
| 9. | Laser gun |
| 10. | Material jet |
| 11. | Laser beam |
| 12. | Layer structure |
| 13. | Construction plate |
| 14. | Workpiece |
| 15. | Matrix material |
| 16. | Ceramic particles |
| 17. | Tool punch |
| 18. | Sectional view |
| 19. | – |
| 20. | 3D laser melting machine |

1. Method for producing precise components, preferably machining tools or cold forming tools, cold extrusion punches and dies, by laser melting or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.33XX or DIN EN 10027-2 no. 1.27XX, the combination XX being a two-digit number, and the powder elements being added in particular according to DIN standard EN 10027-2 no. 1.3343 with the short name HS6-5-2C or DIN EN 10027-2 no. 1.2709 with the short name X3NiCoMoTi18-9-5:
1.1 Iron: up to 79.75 mass%,
1.2 Carbon: from 0.86 to 0.94 mass%,
1.3 Chromium: from 3.80 to 4.50 mass%,
1.4 Manganese: less than 0.40 mass%,
1.5 Phosphorus: up to 0.03 mass%,
1.6 Sulfur: up to 0.03 mass%,
1.7 Silicon: less than 0.45 mass%,
1.8 Vanadium: from 1.70 up to 2.00 mass%,
1.9 Tungsten: from 5.9 up to 6.7 mass%,
1.10 Molybdenum: from 4.7 to 5.2 mass%,
a powder alloy being created from said powder elements over the course of the laser sintering process, characterized in that the following powder elements, present in elemental, alloyed or pre-alloyed form, are each additionally added to the alloy separately or in arbitrary combination:
1.11 Tungsten: in the range of between 0.7, 10 and 35 mass%, preferably 10 mass%,
1.12 Titanium: in the range of between 0.2, 3.2 to 10.7 mass%, preferably 3.2 mass%,
1.13 Carbon: in the range of between 0.08, 1.23 up to 4.1 mass%, preferably 1.23 mass%,
1.14 O: in the range of between 0.00 up to 0.02 mass%,
1.15 N: in the range of between 0.00 up to 0.02 mass%,
1.16 Undefined residual substances at less than 0.05 mass%.

2. Method for producing precise components, preferably high-strength components for the aerospace industry in order to achieve high strength with good toughness at a low density, good hot formability and weldability, by laser melting or laser sintering or laser deposit welding or FDM or binder jetting of a powder material, which consists of a mixture of at least two powder elements, the powder mixture being formed by the primary component titanium powder and additional powder alloying elements, which are present in elemental, pre-alloyed or partially pre-alloyed form, the powder elements each being added separately or in arbitrary combination in the following quantities according to the standard DIN EN 10027-2 no. 3.71XX, in particular according to the standard DIN EN 10027-2 no. 3.7165 with the short name Titan Grade 5:
2.1 Titanium: in the range of between 88.74 and 91 mass%,
2.2 Aluminum: in the range of between 5.50 and 6.75 mass%,
2.3 Vanadium: in the range of between 3.50 and 4.50 mass%,
2.4 Hydrogen (H): less than 0.02 mass%,
a powder alloy being created from said powder elements over the course of the laser melting process, characterized in that the following powder elements, present in elemental, alloyed or pre-alloyed form, are each additionally added to the alloy separately or in arbitrary combination:
2.5 Tungsten: in the range of between 0.7, 10 and 35 mass%, preferably 10 mass%,
2.6 Titanium: in the range of between 0.2, 3.2 to 10.7 mass%, preferably 3.2 mass%,
2.7 Carbon: in the range of between 0.08, 1.23 up to 4.1 mass%, preferably 1.23 mass%,
2.8 O: in the range of between 0.00 up to 0.02 mass%,
2.9 N: in the range of between 0.00 up to 0.02 mass%,
2.10 Undefined residual substances at less than 0.05 mass%.

3. Method for producing precise components, preferably machining tools or cold forming tools, in particular high-performance cutting tools (dies and punches); milling cutters, broaches; sectioning, punching and cutting tools; thread rolling and rolling tools; woodworking tools; machine knives; plastics molds, measuring tools, tools for stamping technology; drawing, deep-drawing and extrusion tools; pressing tools for the ceramic and pharmaceutical industry; cold rolls for multi-roll stands; forming and bending tools, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.23XX, in particular according to the standard DIN EN 10027-2 no. 1.2379 with the short name X155CrVMo12-1 and the chemical composition C 1.55 / Si 0.4 / Mn 0.3 / Cr 11.8 / Mo 0.75 / V 0.82, or other chromium-nickel steels being added, in particular if the chemical composition is quantified as follows:
3.1 Iron: up to 84.05 mass%,
3.2 Carbon: up to 1.55 mass%,
3.3 Chromium: up to 12.00 mass%,
3.4 Molybdenum: up to 0.80 mass%,
3.5 Vanadium: up to 0.90 mass%,
3.6 Silicon: up to 0.40 mass%,
3.7 Manganese: up to 0.30 mass%,
characterized in that the following powder elements, present in elemental, alloyed or pre-alloyed form, are each additionally added to the alloy separately or in arbitrary combination:
3.8 Tungsten: in the range of between 0.7, 10 and 35 mass%, preferably 10 mass%,
3.9 Titanium: in the range of between 0.2, 3.2 to 10.7 mass%, preferably 3.2 mass%,
3.10 Carbon: in the range of between 0.08, 1.23 up to 4.1 mass%, preferably 1.23 mass%,
3.11 O: in the range of between 0.00 up to 0.02 mass%,.

4. Method for producing precise components from austenitic stainless steel 1.4404 (316 L) with good acid resistance, preferably for chemical apparatus construction, in sewage treatment plants and in the paper industry, for mechanical components with increased requirements for corrosion resistance, in particular in media containing chloride and for hydrogen, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.44XX, in particular according to the standard DIN EN 10027-2 no. 1.4404 with the EN short name X2CrNiMo17-12-2:
4.1 Iron: up to 62.80 mass%,
4.2 Carbon: up to 0.03 mass%,
4.3 Silicon: up to 1.00 mass%,
4.4 Manganese: up to 2.00 mass%,
4.5 Phosphorus: up to 0.05 mass%,
4.6 Sulfur: up to 0.02 mass%,
4.7 Chromium: in the range of between 16.50 and 18.50 mass%,
4.8 Molybdenum: in the range of between 2.00 up to 2.50 mass%,
4.9 Nickel: in the range of between 10.00 up to 13.00 mass%,
4.10 Nitrogen: up to 0.11 mass%,
characterized in that the following powder elements, present in elemental, alloyed or pre-alloyed form, are each additionally added to the alloy separately or in arbitrary combination:
4.11 Tungsten: in the range of between 0.7, 10 and 35 mass%, preferably 10 mass%,
4.12 Titanium: in the range of between 0.2, 3.2 to 10.7 mass%, preferably 3.2 mass%,
4.13 Carbon: in the range of between 0.08, 1.23 up to 4.1 mass%, preferably 1.23 mass%,
4.14 O: in the range of between 0.00 up to 0.02 mass%,
4.15 N: in the range of between 0.00 up to 0.02 mass%,
4.16 Undefined residual substances at less than 0.05 mass%.

5. Method for producing precise components from an iron-nickel-chromium-molybdenum alloy with the addition of nitrogen, preferably for use in chemistry and petrochemistry, in ore digestion plants, in environmental and marine technology, and in oil and gas extraction, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.45XX, in particular according to the standard DIN EN 10027-2 no. 1.4562 with the EN material short name X1NiCrMoCu32-28-7:
5.1 Iron: up to 60.92 mass%,
5.2 Carbon: up to 0.02 mass%,
5.3 Silicon: up to 0.30 mass%,
5.4 Manganese: up to 2.00 mass%,
5.5 Phosphorus: up to 0.02 mass%,
5.6 Sulfur: up to 0.10 mass%,
5.7 Chromium: in the range of between 26.00 and 28.00 mass%,
5.8 Copper: in the range of between 1.00 and 1.40 mass%,
5.9 Nickel: in the range of between 30 and 32 mass%,
5.10 Molybdenum: in the range of between 6.00 and 7.00 mass%,
5.11 Nitrogen: in the range of between 0.15 and 0.25 mass%, characterized in that
the following powder elements, present in elemental, alloyed or pre-alloyed form, are each additionally added to the alloy separately or in arbitrary combination:
5.12 Tungsten: in the range of between 0.7, 10 and 35 mass%, preferably 10 mass%,
5.13 Titanium: in the range of between 0.2, 3.2 to 10.7 mass%, preferably 3.2 mass%,
5.14 Carbon: in the range of between 0.08, 1.23 up to 4.1 mass%, preferably 1.23 mass%,
5.15 O: in the range of between 0.00 up to 0.02 mass%,
5.16 N: in the range of between 0.00 up to 0.02 mass%,
5.17 Undefined residual substances at less than 0.05 mass%.

6. Method for producing precise components, preferably machining tools as high-speed steel with high toughness and good cutting performance or cold forming tools, in particular high-performance cutting tools (dies and punches); milling cutters, broaches; sectioning, punching and cutting tools; thread rolling and rolling tools; woodworking tools; machine knives; plastics molds, measuring tools, tools for stamping technology; drawing, deep-drawing and extrusion tools; pressing tools for the ceramic and pharmaceutical industry; cold rolls for multi-roll stands; forming and bending tools, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.33XX, in particular according to the standard DIN EN 10027-2 no. 1.3343 with the short name HS6-5-2C, or other chromium-nickel steels being added, in particular if the chemical composition is quantified as follows:
6.1 Iron: up to 79.75 mass%,
6.2 Carbon: in the range of between 0.86 and 0.94 mass%,
6.3 Chromium: in the range of between 3.80 and 4.50 mass%,
6.4 Manganese: less than 0.40 mass%,
6.5 Phosphorus: less than 0.03 mass%,
6.6 Sulfur: up to 0.03 mass%,
6.7 Silicon: less than 0.45 mass%,
6.8 Vanadium: in the range of between 1.70 up to 2.00 mass%,
6.9 Tungsten: in the range of between 5.9 up to 6.7 mass%,
6.10 Molybdenum: in the range of between 4.7 up to 5.2 mass%, characterized in that
the following powder elements, present in elemental, alloyed or pre-alloyed form, are each additionally added to the alloy separately or in arbitrary combination:
6.11 Carbon in the form of diamond powder: in the range of between 1.15 to 50 mass%, preferably 15 mass%.

7. Method for producing precise components, preferably machining tools as high-speed steel with high toughness and good cutting performance or cold forming tools, in particular high-performance cutting tools (dies and punches); milling cutters, broaches; sectioning, punching and cutting tools; thread rolling and rolling tools; woodworking tools; machine knives; plastics molds, measuring tools, tools for stamping technology; drawing, deep-drawing and extrusion tools; pressing tools for the ceramic and pharmaceutical industry; cold rolls for multi-roll stands; forming and bending tools, by laser melting or laser sintering or laser deposit welding or FDM or binder jetting of a powder material, which consists of a mixture of at least two powder elements, the powder mixture being formed by the primary component iron powder and additional powder alloying elements, which are present in elemental, pre-alloyed or partially pre-alloyed form, the powder elements each being added separately or in arbitrary combination in the following quantities according to the standard DIN EN 10027-2 no. 1.33XX, in particular according to the standard DIN EN 10027-2 no. 1.3343 with the short name HS6-5-2C, or other chromium-nickel steels being added, in particular if the chemical composition is quantified as follows:
7.1 Iron: up to 79.75 mass%,
7.2 Carbon: in the range of between 0.86 and 0.94 mass%,
7.3 Chromium: in the range of between 3.80 and 4.50 mass%,
7.4 Manganese: less than 0.40 mass%,
7.5 Phosphorus: less than 0.03 mass%,
7.6 Sulfur: up to 0.03 mass%,
7.7 Silicon: less than 0.45 mass%,
7.8 Vanadium: in the range of between 1.70 up to 2.00 mass%,
7.9 Tungsten: in the range of between 5.9 up to 6.7 mass%,
7.10 Molybdenum: in the range of between 4.7 up to 5.2 mass%, characterized in that
the following powder elements, present in elemental, alloyed or pre-alloyed form, are each additionally added to the alloy separately or in arbitrary combination:
7.11 Boron: up to 56.18 mass%,
7.12 Nitrogen: up to 43.53 mass%.

8. Method according to claim 1, characterized in that powdered boron nitrides and/or a powdered diamond powder and/or a powdered carbide powder are added to the powder composition according to claim 1.

9. Method according to claim 8, characterized in that the boron nitride and/or carbide and/or diamond powder bodies used have a cubic shape (CBN) and/or a broken shape with a grain size in the range of between 1 to 40 micrometers.

10. Method according to claim 1, characterized in that the melting temperature of the ceramic and/or carbide powder composition used is far above the melting temperature of the metal powder compositions and only the metal powder compositions are melted in the SLM or SLS or laser deposit welding or FDM or binder jetting process.

11. Method for producing precise components, preferably machining tools or cold forming tools, cold extrusion punches and dies, by laser melting or laser sintering or laser deposit welding or FDM or binder jetting of a powder material, which consists of a mixture of at least two powder elements, characterized by the following method steps:
1. Processing a material 1.33XX or 3.71XX or 1.23XX or 1.44XX or 1.45XX or 1.27XX in the SLM or SLS method
2. Mixing the 1.33XX or 3.71XX or 1.23XX or 1.44XX or 1.45XX or 1.27XX material with carbides
3. In particular, mixing the 1.33XX or 3.71XX or 1.23XX or 1.44XX or 1.45XX or 1.27XX material with 1% to 50% carbides
4. Mixing the base material with carbides according to number 3 in the SLM or SLS method
5. Mixing the selected materials mentioned here with carbides
6. Mixing powder components according to numbers 2 to 5 with boron nitrides
7. General mixing of base material with carbides for additive manufacturing (FDM, LAS...)
8. Adding diamond powder to all powder preparations according to numbers 1 to 7.

12. Method according to claim 11, characterized by the following method steps:
1. Processing the material 1.3343 or 3.7165 or 1.2379 or 1.4404 or 1.4562 or 1.2709 in the SLM or SLS method
2. Mixing the 1.3343 or 3.7165 or 1.2379 or 1.4404 or 1.4562 or 1.2709 material with carbides
3. In particular, mixing the 1.3343 or 3.7165 or 1.2379 or 1.4404 or 1.4562 or 1.2709 material with 1% to 50% carbides
4. Mixing the base material with carbides according to number 3 in the SLM or SLS or laser deposit welding or FDM or binder jetting method
5. Mixing the selected materials mentioned here with carbides
6. Mixing powder components according to numbers 2 to 5 with boron nitrides
7. General mixing of base material with carbides for additive manufacturing (FDM, LAS...)
8. Adding diamond powder to all powder preparations according to numbers 1 to 7.

13. Metal powder alloys, the at least one metal powder composition being composed of powders according to the following material classes, the generalization XX corresponding to the following DIN standard classes, the letter sequence XX substituting a two-digit combination on the end of the relevant DIN standard, the powder composition being characterized by the following material classes alone or in any combination with one another and from any composition according to the following material classes:
DIN 1.33XX, preferably, but not limited to DIN 1.3343
DIN 3.71XX, preferably, but not limited to DIN 3.7165
DIN 1.23XX, preferably, but not limited to DIN 1.2379
DIN 1.44XX, preferably, but not limited to DIN 1.4404
DIN 1.45XX, preferably, but not limited to DIN 1.4562
DIN 1.27XX, preferably, but not limited to DIN 1.2709
DIN 3.23XX, preferably, but not limited to DIN 1.2383
DIN 2.08XX, preferably, but not limited to DIN 2.0855
INCONEL XXX, preferably, but not limited to INCONEL 718.

14. Metal workpieces produced using metal powder alloys according to claim 13.

15. Metal workpieces which are produced according to the method of claim 1.
